(19) United States
(12) Patent Application Publication
(10) Pub. No.: US 2004/0217110 A1
(43) Pub. Date: Nov. 4, 2004

(54) Heating blanket and methods for curing composites

(76) Inventor: Brent Gray, SeaTac, WA (US)

Correspondence Address: GRAYBEAL, JACKSON, HALEY LLP, 155 - 108TH AVENUE NE, SUITE 350, BELLEVUE, WA, 98004-5901, US

(21) Appl. No.: 10/427,530

(22) Filed: Apr. 30, 2003

(51) Int. Cl. H05B 3/34

(52) U.S. Cl. 219/528; 219/549

(57) ABSTRACT

A heating blanket includes a body operable to generate heat from power supplied by two leads. The body includes a support ply having a hole for receiving the lead so that a portion of the body may secure the lead to the blanket and protect the coupling of the lead to the blanket. The body also includes a heating element coupled to a stretchable matt. When the matt is stretched, the heating element stretches in the same direction and can continue to generate heat. Consequently, the body of the heating blanket can maintain sufficient contact with a composite assembly as a contour of the composite assembly's surface changes, and the blanket can adequately cure regions of an assembly that would otherwise be difficult to cure. Because the hole is in the support ply, the support ply reinforces the entire circumference of the hole. Consequently, the portion of the body can protect the coupling of the leads to the body of the blanket through multiple uses of the blanket.

### BACKGROUND

Composite assemblies are used to form many different devices and/or structures, such as an aileron of an airplane's wing, a flap on the trailing edge of an airplane wing, and a boat hull. One of the many reasons for this is that composite assemblies are easily contoured into complex curves such as a boat's hull or the leading edge of a wing's flap. Another reason is that composite assemblies may be easily repaired in the field, and thus, may reduce the time spent completing a repair.

Composite assemblies are formed by adhering together two or more plies, or sheets of material such as metal, woven and/or non-woven carbon, fiberglass, and/or Kevlar® fibers. For example, forming a composite assembly may involve laying an initial ply of fiberglass prepreg—fiberglass cloth impregnated with adhesive—against a tool or existing device or part under repair to form the desired contour of the composite assembly. Then, a subsequent ply of fiberglass prepreg may be laid against the initial ply, which may be followed by still another ply of fiberglass prepreg. To obtain the desired composite assembly, any desired number of fiberglass prepreg plies may be used in the laying up process.

To complete the composite assembly heat and/or pressure are applied to the assembly to cure the adhesive and couple the many plies of fiberglass together. To ensure a complete cure, the temperature of the entire repair should be elevated above the specific cure temperature of the adhesive and maintained at the elevated temperature for a specific duration. To accomplish this, a heating blanket is typically secured to the composite assembly with tape and/or a vacuum bag for the duration of the cure, and then, after the cure is complete, is removed from the assembly. If the adhesive is not adequately cured, the composite assembly may not function as desired. Thus, the heating blanket plays an important role in forming composite assemblies.

FIG. 1 is a perspective view of a conventional heating blanket 10. FIG. 2 is a perspective view of the heating blanket 10 of FIG. 1 that is secured to a composite assembly with a vacuum bag to cure the adhesive in the assembly. Referring to FIG. 1, the heating blanket 10 includes a body 12 operable to generate heat, two leads 14 coupled to the body 12 to supply the body 12 power, and a tab 16 to secure the leads 14 to the body 12 to protect the coupling of the leads 14 to the body 12. The body 12 includes a reinforcement ply (not shown) that allows the body 12 to flex but not stretch. To secure the leads 14, the leads 14 extend between a top ply 17 and bottom ply 18 coupled together, and emerge from the edge 20 of the tab 16. Thus, the edge 20 includes a seam 22 between the top and bottom plies 16 and 18, respectively, from which the leads 14 emerge from the tab 16.

Referring to FIG. 2, to cure a region of the composite assembly 24, heat and pressure are applied to the region. The heating blanket 10 is first placed on the region of the composite assembly 24. Next, a bag 26 is placed over the heating blanket 10 and surrounding area of the region and attached to the assembly with sealant tape 28 to generate a sealed space between the region and the bag 26 that contains the heating blanket 10. The air is then pumped out of the sealed space to generate a vacuum over the region, and thus pressure on the composite assembly. The pressure forces the plies of the composite assembly 24 together and the heating blanket 10 against the assembly 24 to remove gaps (not shown). Gaps between the heating blanket 10 and the composite assembly 24 may obstruct the transfer of heat from the blanket 10 to the composite assembly 24, and thus may reduce the local temperature of the assembly 24 where the gaps exist. To access the heating blanket's leads 14 to power the blanket 10, the leads 14 extend through a portion of the sealant tape 28 between the bag 26 and assembly 24.

Unfortunately, repeatedly removing the heating blanket 10 from a composite assembly can damage the blanket 10, and thus, reduce the life of the blanket 10. One typically removes the heating blanket 10 by grabbing and pulling on the leads 14. This often causes the seam 22 of the edge 20 to separate, and repeatedly removing the blanket 10 in this manner can cause the plies 16 and 18 to eventually separate. Thus, the tab 16 may quickly lose its ability to protect the coupling of the leads 14 to the body 12.

In addition, the blanket 10 may not provide a good transfer of heat to an assembly that has a change in its surface contour. For example, the heating blanket 10 placed over a small ridge in an assembly's surface may not contact the assembly's surface at the root of the ridge, and thus, a gap between the heating blanket 10 and the assembly may exist. Thus, the adhesive and plies in the root of the ridge may not reach the desired cure temperature and/or remain at the desired cure temperature long enough to complete the cure. Consequently, the plies in the root of the ridge may not be sufficiently coupled together—typically referred to as bridging—, and the assembly may not function as desired. Furthermore, if the blanket 10 is stretched to contact the root of the ridge, the blanket 10 may be damaged and not be able to generate heat as designed.

### SUMMARY

In one aspect of the invention, a heating blanket includes a body operable to generate heat from power supplied by a lead. The body includes a support ply having a hole for receiving the lead so that a portion of the body may secure the lead to the blanket and protect the coupling of the lead to the blanket. Because the hole is in the support ply, the support ply reinforces the circumference of the hole. Thus, the blanket may be removed from a composite assembly by grabbing and pulling the leads, as is typically done, without causing much damage to the hole through which the lead emerges from the blanket. Consequently, the portion of the body can protect the coupling of the leads to the body of the blanket through multiple uses of the blanket.

In another aspect of the invention, a heating blanket includes a body that may be stretched over and/or around changes in the contour of a surface to adequately cure regions of a composite assembly that would otherwise be difficult to cure. The body includes a heating element coupled to a stretchable matt and operable to generate heat. When the matt is stretched in the X and/or Y directions, the heating element stretches in the same direction and can continue to generate heat. Consequently, the body of the heating blanket can maintain sufficient contact with the composite assembly as a contour of the composite assembly's surface changes. Therefore, the blanket can maintain a temperature in a composite assembly that will adequately cure the adhesive in a ridge or other type of change in the assembly's surface contour.

### BRIEF DESCRIPTION OF THE FIGURES

FIG. 1 is a perspective view of a conventional heating blanket.

FIG. 2 is a perspective view of the conventional heating blanket of FIG. 1 secured to a composite assembly.

FIG. 3 is a perspective view of a heating blanket according to an embodiment of the invention.

FIG. 4 is a perspective view of a portion of the heating blanket of FIG. 3 that incorporates a support ply, according to an embodiment of the invention.

FIG. 5 is a view of the heating element incorporated in the heating blanket of FIG. 3, according to an embodiment of the invention.

FIG. 6 is a perspective view of a heating blanket according to another embodiment of the invention.

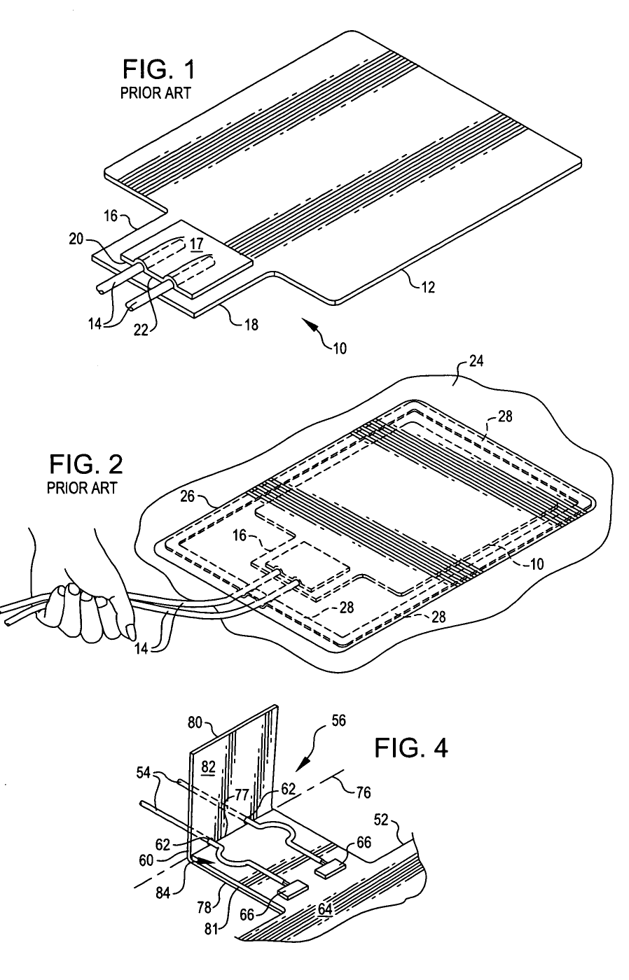

### DETAILED DESCRIPTION

In the following detailed description of exemplary embodiments of the invention, reference is made to the accompanying drawings, which form a part hereof. The detailed description and the drawings illustrate specific exemplary embodiments by which the invention may be practiced. These embodiments are described in sufficient detail to enable those skilled in the art to practice the invention. It is understood that other embodiments may be utilized, and other changes may be made, without departing from the spirit or scope of the present invention. The following detailed description is therefore not to be taken in a limiting sense, and the scope of the present invention is defined only by the appended claims.

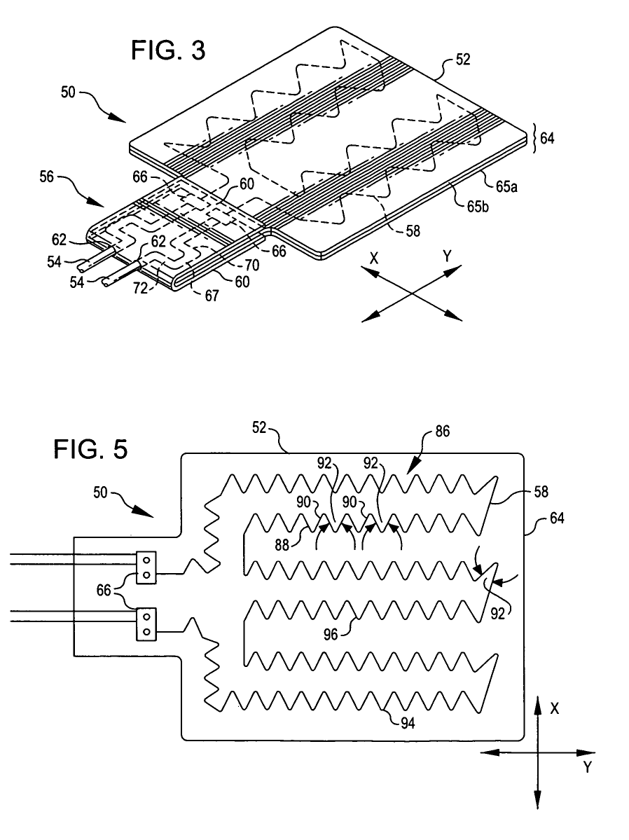

FIG. 3 is a perspective view of a heating blanket 50 according to an embodiment of the invention. The heating blanket 50 includes a body 52 to generate heat and to radiate the heat to a structure or device such as a composite assembly (not shown), and a lead 54 (two shown) coupled to the body 52 to provide the body 52 power to generate heat. The body 52 includes a portion 56 to secure the leads 54 to the body 52 and protect the coupling of the leads 54 to the body 52. The portion 56 includes a support ply 60 that has hole 62 (two shown), which receives the lead 54. Because the hole 62 is through the support ply 60, the ply 60 reinforces the circumference of the hole 62. Therefore, the blanket 50 may be removed from a composite assembly by grabbing and pulling the lead 54, as is typically done, without causing much damage to the hole 62, and thus, the portion 56 of the body 52 may repeatedly protect the connection of the lead 54 to the body 52.

The body 52 also includes a heating element 58 (discussed in greater detail in conjunction with FIG. 5) coupled to the leads 54 to generate heat. The heating element 58 can stretch and continue to generate heat when the body 52 stretches to maintain sufficient contact with a composite assembly (not shown) as a contour (not shown) of the assembly's surface changes. Therefore, the blanket 50 can maintain a temperature in a composite assembly that will adequately cure the adhesive in a ridge or other type of change in the assembly's surface contour.

Still referring to FIG. 3, the body 52 includes a matt 64 that is stretchable in the X and/or Y directions to maintain sufficient contact with the composite assembly as a contour of the composite assembly's surface changes. The matt 64 may be made of any desirable material, such as conventional silicone rubber, that can stretch and withstand the heat generated by the heating element 58 when the blanket 50 is used. Stretch in the matt 64 is different than flex in the matt 64. When the matt 64 is stretched, the matt's overall length increases. When the matt 64 is flexed, the matt's overall length remains the same. For example, pulling one end of the matt 64 away from the other end causes the matt 64 to stretch. But bending the matt 64 over a rod causes the matt 64 to flex rather than stretch.

In one embodiment, the body 52 may be made by placing the heating element 58 between two plies 65a and 65b of conventional silicon rubber and then vulcanizing the plies 65a and 65b to form the matt 64. In other embodiments where stretch in the body 52 is not important and flex remains desirable, the body 52 may be made by placing a stretchable and/or conventional heating element between two or more plies of silicone rubber and reinforcement plies of woven material, such as fiberglass, carbon and/or Kevlar®, and then vulcanizing the silicone rubber to form the matt 64.

Still referring to FIG. 3, the blanket 50 includes a buss 66 to couple a lead 54 to the heating element 58 of the body 50. In one embodiment, the blanket 50 includes two busses 66 each disposed in the portion 56 and each coupled to one of the respective leads 54 using any desired technique such as, soldering and/or riveting. After multiple uses of a conventional blanket 10 (FIG. 1) that includes removing the blanket 10 from a composite assembly by pulling on the leads 14 (FIG. 1), the coupling of one or more of the leads 14 to a heating element frequently becomes damaged. Consequently, the heating element in the body 10 may not generate and/or radiate sufficient heat as desired.

To protect the coupling of the leads 54 to the heating element 58, the portion 56 of the body 52 secures a portion 67 of the lead 54 to the body 52. In one embodiment, each lead 54 extends through the portion 56 from one of the respective busses 66 to one of two respective holes 62, through which, each lead 54 emerges from the body 52. Each lead 54 extends between the matt 64 and support ply 60 that are coupled together by vulcanizing silicone rubber included in the ply 60 and the matt 64. In addition, each lead 54 extends between the support ply 60 and the matt 64 in two or more directions, that is, each lead 54 serpentines through the portion 56. For example, a portion 70 of one of the leads 54 may extend in a first direction that is away from the other lead 54, and another portion 72 of the lead 54 may extend in a second direction that is opposite the first direction or toward the other lead 54. Thus, tension on the leads caused by pulling on them can be supported by elastic deformation in the support ply 60 and/or the matt 64 without the coupling of the leads 54 to the busses 66 supporting the tension.

Still referring to FIG. 3 to help keep the matt 64 and the support ply 60 coupled together, the support ply 60 includes the holes 62 through which each lead 54 extends. By reinforcing the circumference of each hole 62, the support ply 60 helps prevent damage to each hole 62 as one or both of the leads 54 are pulled to remove the blanket 50 from a composite assembly. Thus, the support ply 60 helps reduce damage to the portion 56 of the body 52 as the leads 54 are pulled. The support ply 60 may be any desirable material capable of not permanently deforming under tension, such as fiberglass, carbon, Kevlar® and/or any conventional woven material. In one embodiment, the support ply 60 includes woven fiberglass.

FIG. 4 is a perspective view of the portion 56 of the heating blanket 50 of FIG. 3 that incorporates the support ply 60, according to an embodiment of the invention. The ply 65b (FIG. 3) of the matt 64 has been omitted from FIG. 4 for clarity. In this embodiment, the portion 56 is formed by folding a portion of the support ply 60 about an axis 76. By folding the support ply 60 about the axis 76, the support ply 60 may provide reinforcement in areas of the portion 56 other than the circumference of the holes 62, such as along an edge of the portion 56 where the axis 76 may be located. Thus, the support ply 60 may also help reduce damage in other areas of the portion 56 caused by pulling one or more of the leads 54.

In one embodiment, the axis 76 is located at an edge 77 of the portion 56, and the holes 62, through which the leads 54 extend, are located on the axis 76. The support ply 60 includes a first section 78 and a second section 80 extending from the first section 78. The first section 78 is mounted to a first surface 81 of the matt 64 by vulcanizing conventional silicone rubber of the matt 64 through the first section 78. The second section 80 of the support ply 60 includes conventional silicone rubber 82 that, when vulcanized with the silicone rubber in the matt 64, form an interface 84. The leads 54 extend from the busses 66 through the interface 84 and emerge from the body 52 through the holes 62 located at the axis 76. Thus, the support ply 60 helps prevent damage to the portion 56 as one or both of the leads 54 are pulled by reinforcing the circumference of each hole 62 and the edge 77 of the portion 56.

FIG. 5 is a view of the heating element 58 incorporated in the heating blanket 50 of FIG. 3, according to an embodiment of the invention. The heating element 58 can stretch and continue to generate heat when the body 52 stretches to maintain sufficient contact with a composite assembly (not shown) as a contour (not shown) of the assembly's surface changes. Therefore, the blanket 50 can maintain a temperature in a composite assembly that will adequately cure the adhesive in a ridge or other type of change in the assembly's surface contour.

To allow the heating element 58 to stretch with the matt 64 of the body 50 as the matt 64 stretches, the heating element 58 extends through the matt 64 in a zigzag pattern 86. The zigzag pattern 86 includes a plurality of zig portions 88 that extend in one direction and a plurality of zag portions 90 that extend in another direction. Each zig portion 88 is located between two zag portions 90, and each zag portion 90 is located between two zig portions 88. The zigzag pattern 86 also includes a plurality of angles 92 formed by the different directions each zig and zag portions 88 and 90, respectively, extend relative to respective adjacent zag and zig portions 90 and 88, respectively. As the heating element 58 stretches, one or more of the plurality of angles 90 changes. For example, stretching the matt 64 in the Y direction may cause the angle 92 to increase. By changing the angles 92 between each zig and zag portions 88 and 90, respectively, the heating element 58 can stretch and continue to generate heat when the matt 64 stretches.

In one embodiment, each zig portion 88 and zag portion 90 may be straight and each angle 92 between the zig portions 88 and the zag portions 90 may be substantially the same. In other embodiments one or more zig portions 88 and/or one or more zag portions 90 may be similarly or differently curved in any direction as desired. Additionally or alternatively the zigzag pattern 86 may be in the form of a rectilinear shape such as a square or rectangle, a triangular shape, a curved shape such as the shape of a sine wave and/or any desired shape.

Still referring to FIG. 5, in one embodiment the heating element 58 is an electric resistance heating element that generates heat by resisting electric current flowing through the element 58. The heating element 58 zigzags through a substantial portion of the matt 64 in the X direction as well as in the Y direction, and each zig and zag portion 88 and 90, respectively, in the Y direction is smaller than each zig and zag portion 94 and 96, respectively, in the X direction. To receive power from the leads 54, the heating element 58 is coupled to the busses 66 using any desired technique such as, soldering and/or riveting.

Other embodiments are contemplated. For example, the heating element 58 may include more than one circuit to reduce the total resistance of a single circuit incorporated in the heating element 58. This may be desirable when the matt 64 is densely populated with the heating element 58 to generate a substantial amount of heat per unit of area. If the matt 64 was densely populated with a heating element 58 that incorporated one circuit, the length of the heating element 58 would significantly increase the resistance of the heating element 58, and thus significantly decrease the amount of heat generated by the heating element 58.

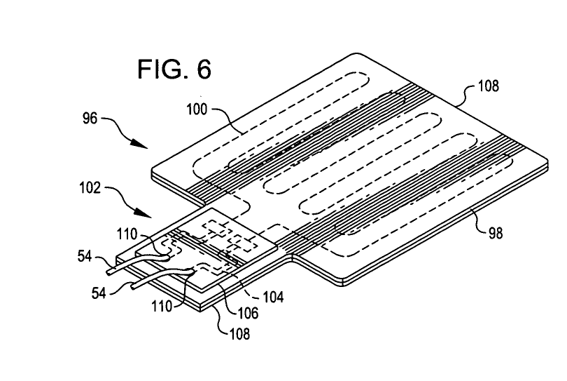

FIG. 6 is a perspective view of a heating blanket 96 according to another embodiment of the invention. The heating blanket 96 is similar to the heating blanket 50 in FIGS. 3-5 except the body 98 includes a heating element 100 that does not stretch like the heating element 58 (FIGS. 3 and 5). Thus, the blanket 96 is typically used on composite assemblies that do not include a surface contour (not shown) that changes because stretching the heating element 100 may significantly damage the element 100.

The portion 102 of the body 98 secures a portion 104 of the leads 54 to the body 98 and protects the coupling of the leads 54 to the heating element 100. The portion 102 includes a support ply 106 coupled to a matt 108 as described elsewhere herein. In one embodiment, the support ply 106 includes two holes 110 each of which receives one of the respective leads 54. Because each hole 110 is through the support ply 106, the ply 106 reinforces the circumference of each hole 110. Therefore, the blanket 96 may be removed from a composite assembly by grabbing and pulling the leads 54, as is typically done, without causing much damage to the holes 110, and thus, the portion 102 may protect the connection of the leads 54 to the body 98 through multiple uses of the blanket 96.

What is claimed is:

1. A blanket for generating heat comprising:
a body including a support ply having a hole for receiving a lead, wherein the support ply is operable to secure to the blanket a lead inserted into the hole, and wherein the body is operable to generate heat.

2. The blanket of claim 1 wherein the body is operable to radiate heat.

3. The blanket of claim 1 wherein the body includes:
an electric resistance heating element operable to generate heat; and
a bus operable to couple the electric resistance heating element with an electric lead.

4. The blanket of claim 1 wherein the body includes a matt and the support ply is coupled with the matt.

5. The blanket of claim 4 wherein:
the matt includes silicone, and
the support ply includes woven fiberglass.

6. The blanket of claim 4 wherein the support ply includes a first section mounted to a first surface of the matt and a second section that extends from the first section and is mounted to a second surface of the matt.

7. The blanket of claim 6 wherein the second section of the support ply is folded along an axis and the hole is located at the axis.

8. The blanket of claim 6 wherein the second section includes the hole.

9. The blanket of claim 6 wherein the second section and the matt each include silicone, and are coupled to form the interface by vulcanizing silicone included in the matt and the second section.

10. The blanket of claim 6 further comprising a lead having a portion inserted through the hole and disposed in the interface, wherein the lead is operable to provide the body power.

11. The blanket of claim 10 wherein the portion of the lead disposed in the interface extends in at least two different directions.

12. The blanket of claim 11 wherein the different directions include a first direction and a second direction that is opposite the first direction.

13. A blanket for generating heat comprising:
a body including a stretchable heating element coupled with a stretchable matt, wherein the heating element is operable to generate heat, and when the matt is stretched in an X direction and a Y direction, the heating element stretches in the same directions.

14. The blanket of claim 13 wherein the heating element forms a zigzag pattern in at least one of the X and Y directions.

15. The blanket of claim 13 wherein the heating element includes an electric resistance heating element.

16. The blanket of claim 13 wherein the stretchable matt includes silicone.

17. The blanket of claim 13 further comprising:
a lead operable to provide the heating element power, and
a support ply coupled with the matt and operable to secure the lead to the blanket.

18. The blanket of claim 17 wherein a portion of the lead is disposed between the support ply and the matt, and extends in at least two directions.

19. The blanket of claim 18 wherein the directions that the portion of the lead extends include a first direction and a second direction opposite the first direction.

20. A method for securing a lead to a heating blanket, the method comprising:
inserting a portion of a lead through a hole in a support ply of a heating blanket; and
mounting the portion of the lead to the heating blanket.

21. The method of claim 20 wherein mounting the portion of the lead includes:
disposing the portion of the lead between a matt of the heating blanket and the support ply;
coupling the support ply with the matt.

22. The method of claim 21 wherein:
coupling the support ply to the matt includes:
coupling a first section of the support ply with the matt,
folding a second section of the support ply toward the first section about an axis, and
coupling the second section with the matt; and
inserting a portion of the lead through the hole includes inserting the portion of the lead through a hole located at the axis.

23. The method of claim 21 wherein disposing a portion of the lead between the support ply and the matt includes extending the lead in at least two directions.

24. The method of claim 23 wherein extending the lead in at least two directions includes extending the lead in a first direction and a second direction opposite the first direction.

25. The method of claim 22 wherein the second section and the matt each include silicone, and coupling the second section with the matt includes vulcanizing silicone in the second section and the matt.

26. A method for heating a composite assembly, the method comprising:
stretching a heating element of a heating blanket over a composite assembly; and
generating heat in the heating element.

27. The method of claim 26 wherein stretching a heating element includes increasing an angle in a zigzag pattern formed by the heating element in the blanket.
